(19) United States
(12) Patent Application Publication
(10) Pub. No.: US 2018/0349712 A1
(43) Pub. Date: Dec. 6, 2018

(54) BOUNDARY LINE RECOGNITION APPARATUS

(71) Applicants: SOKEN, INC., Nisshin-city (JP); DENSO CORPORATION, Kariya-city (JP)

(72) Inventors: Shunya KUMANO, Nisshin-city (JP); Kenta HOKI, Kariya-city (JP); Taiki KAWANO, Nisshin-city (JP)

(21) Appl. No.: 15/996,777

(22) Filed: Jun. 4, 2018

(30) Foreign Application Priority Data
Jun. 5, 2017 (JP) 2017-110873

(51) Int. Cl. G06K 9/00; G08G 1/0962

(52) U.S. Cl. CPC G06K 9/00798; G08G 1/09626

(57) ABSTRACT

A boundary line recognition apparatus recognizes a boundary line that demarcates a driving lane in which an own vehicle is driving and includes a candidate detecting unit, a dowel bar determining unit, and a boundary line recognizing unit. The candidate detecting unit detects line types of boundary line candidates that are candidates for the boundary line and a quantity of boundary line candidates of the same line type, based on detection data of the boundary line candidates acquired from a detecting unit that detects the boundary line candidates. The dowel bar determining unit determines whether or not the boundary line candidates are formed by dowel bars embedded in a road, based on the line type and quantity detected by the candidate detecting unit. The boundary line recognizing unit eliminates the boundary line candidates that are determined to be formed by the dowel bars and recognizes the boundary line.

### CROSS-REFERENCE TO RELATED APPLICATION

This application is based on and claims the benefit of priority from Japanese Patent Application No. 2017-110873, filed Jun. 5, 2017. The entire disclosure of the above application is incorporated herein by reference.

### BACKGROUND

### Technical Field

The present invention relates to a technology for recognizing a boundary line that demarcates a driving lane in which a vehicle is driving.

### Related Art

As boundary lines that demarcate a driving lane in which a vehicle is driving, there are solid white lines, broken white lines, lines formed by cat's eyes or Botts' dots arranged in a series of dots, and the like. In addition, a technology for assisting the driving of a vehicle through recognition of such boundary lines is known.

For example, lane departure warning and lane keeping assist are known as technologies for driving assistance. In lane departure warning, a driver is issued a warning through audio, a display, or the like, when an own vehicle moves outside of a boundary line without the driver intentionally driving to do so. In lane keeping assist, steering is controlled such that the own vehicle drives so as to remain in the driving lane. Accurate recognition of boundary lines is required for lane departure warning and lane keeping assist to be properly performed.

JP-A-2011-198276 describes a technology in which image processing is performed on image data that has been picked up by an onboard camera. A white line candidate is extracted from the image data as a boundary line candidate. In the technology described in JP-A-2011-198276, if another white line candidate is present further inward from a white line candidate to be subjected to calculation of a degree of certainty, and if a distance between the white line candidates is within a predetermined range, the degree of certainty of the white line candidate to be subjected to the calculation of the degree of certainty is reduced. The degree of certainty indicates a likelihood of the white line candidate being a white line. As a result, the white line candidate is not recognized as a white line.

When a road is paved with concrete, grooves may be dug in a driving direction of the road and a direction orthogonal to the driving direction, to prevent deformation of a road surface even when the concrete pavement expands and contracts as a result of temperature change and the like. As a result of the grooves, deformation of the road surface is suppressed even when the concrete expands and contracts.

In addition, as a result of metal bars being embedded so as to straddle structures that sandwich the grooves, misalignment of the positions of adjacent structures in a height direction is suppressed. Furthermore, load is transferred between the structures that sandwich the grooves.

The metal bars that are embedded in the direction orthogonal to the grooves that are dug along a width direction of the road, that is, the metal bars that are embedded in the driving direction of the road are referred to as dowel bars. A plurality of dowel bars are embedded in the width direction of the road for each groove.

When a boundary line, such as a white line, is recognized from the image data of a road surface that has been picked up by an onboard camera for boundary line recognition, the white line is recognized based on a difference in luminance between the road surface and the white line. However, in the image data, a difference in luminance also occurs between the road surface and the section in which the dowel bars are embedded.

When a difference in luminance occurs between the dowel bars and the road surface, the section in which the dowel bars are embedded may be erroneously recognized as a boundary line that demarcates the driving lane. In the technology described in JP-A-2011-198276, whether or not to reduce the degree of certainty of a boundary line candidate is determined based solely on whether or not the distance between the boundary line candidates is within a predetermined range. Therefore, a boundary line candidate that is formed by the dowel bars may be erroneously recognized as a boundary line.

### SUMMARY

It is thus desired to provide a technology in which a boundary line candidate that is formed by dowel bars is eliminated from boundary line candidates.

An exemplary embodiment of the present invention provides a boundary line recognition apparatus that is mounted in a vehicle and recognizes a boundary line that demarcates a driving lane in which the own vehicle is driving. The boundary line recognition apparatus includes a candidate detecting unit, a dowel bar determining unit, and a boundary line recognizing unit.

The candidate detecting unit detects line types of boundary line candidates that are candidates for the boundary line and a quantity of boundary line candidates of the same line type, based on detection data of the boundary line candidates acquired from a detecting unit that detects the boundary line candidates.

The dowel bar determining unit determines whether or not the boundary line candidates are formed by dowel bars embedded in a road, based on the line type and quantity detected by the candidate detecting unit. The boundary line recognizing unit eliminates the boundary line candidates that are determined to be formed by the dowel bars by the dowel bar determining unit, and recognizes the boundary line.

A boundary line candidate formed by dowel bars that are embedded along the driving direction of a vehicle is typically a dashed line and a plurality thereof are present in left and right areas of the driving lane with respect to the own vehicle. Therefore, whether or not the boundary line candidates are formed by the dowel bars embedded in the road can be determined based on the line type and quantity detected by the candidate detecting unit.

Consequently, the boundary line candidates formed by the dowel bars can be eliminated from the boundary line candidates, and the boundary line that demarcates the driving lane can be recognized.

Reference numbers within the parentheses in the claims indicate corresponding relationships with specific means described according to the embodiments, described hereafter as aspects, and do not limit the technical scope of the present invention.

### BRIEF DESCRIPTION OF THE DRAWINGS

In the accompanying drawings:

FIG. 1 is a block diagram of a boundary line recognition apparatus according to a first embodiment;

FIG. 2 is a schematic diagram of boundary line candidates detected in a driving lane in the first embodiment;

FIG. 3 is a characteristics diagram for explaining detection of a boundary line candidate in the first embodiment;

FIG. 4 is a flowchart of a boundary line recognition process according to the first embodiment;

FIG. 5 is a schematic diagram of boundary line candidates detected during lane change in the first embodiment;

FIG. 6 is a flowchart of a boundary line recognition process according to a second embodiment;

FIG. 7 is a block diagram of a boundary line recognition apparatus according to a third embodiment;

FIG. 8 is a flowchart of a boundary line recognition process according to the third embodiment; and

FIG. 9 is a flowchart of a boundary line recognition process according to a fourth embodiment.

### DESCRIPTION OF THE EMBODIMENTS

Embodiments of the present invention will hereinafter be described with reference to the drawings.

### 1. First Embodiment

### [1-1. Configuration]

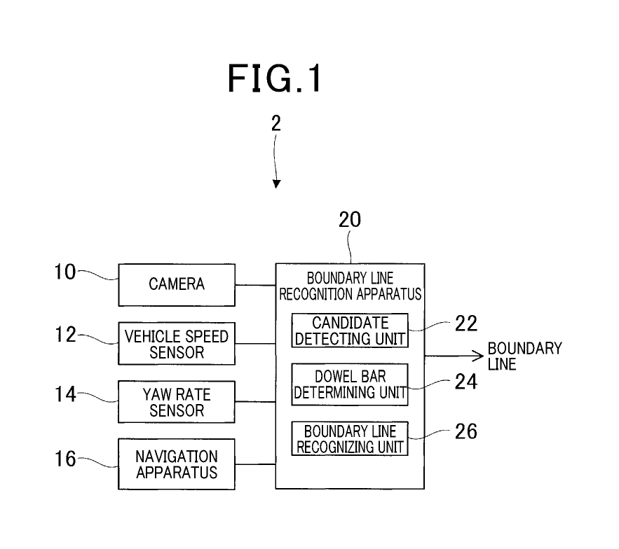

As shown in FIG. 1, an onboard boundary line recognition system 2 according to a first embodiment includes a camera 10, a vehicle speed sensor 12, a yaw rate sensor 14, a navigation apparatus 16, and a boundary line recognition apparatus 20.

The camera 10 is attached to each of the left and right sides and the front and rear of an own vehicle 100. The cameras 10 capture images of the periphery of the own vehicle 100 and output image data to the boundary line recognition apparatus 20. For example, a curvature of a driving lane in which the own vehicle 100 is driving can be calculated through analysis of the image data picked up by the cameras 10.

The vehicle speed sensor 12 detects a vehicle speed of the own vehicle 100. The yaw rate sensor 14 detects a yaw rate of the own vehicle 100 when the own vehicle 100 is driving. The curvature of the driving lane in which the own vehicle 100 is driving can be calculated based on the vehicle speed detected by the vehicle speed sensor 12 and the yaw rate detected by the yaw rate sensor 14.

The navigation apparatus 16 acquires a positioning signal from a positioning satellite, such as a global positioning system (GPS) satellite. The navigation apparatus 16 then determines a current position of the own vehicle 100 in latitude and longitude. The navigation apparatus 16 maps the determined current position of the own vehicle 100 on map data in a map database (DB) and detects the current position of the own vehicle 100 on the map data.

A microcomputer is mounted in the boundary line recognition apparatus 20. The microcomputer includes a central processing unit (CPU), a random access memory (RAM), a read-only memory (ROM), and a semiconductor memory such as a flash memory. A single microcomputer or a plurality of microcomputers may be mounted in the boundary line recognition apparatus 20.

For example, the boundary line recognition apparatus 20 recognizes a boundary line that demarcates the driving lane in which the own vehicle 100 is driving, from the image data picked up by the cameras 10. A driving assistance apparatus (not shown) performs a driving assistance process, such as lane departure warning or lane keeping assist, based on the boundary lines recognized by the boundary line recognition apparatus 20. In lane departure warning, the driver is issued a warning through audio, a display, or the like, when the own vehicle 100 moves outside of the boundary line without the driver intentionally driving to do so. In lane keeping assist, steering is controlled such that the own vehicle 100 drives so as to remain in the driving lane.

Each function of the boundary line recognition apparatus 20 is actualized as a result of the CPU executing a program stored in a non-transitory computer-readable storage medium, such as the ROM or the flash memory. A method corresponding to the program is performed as a result of the CPU running the program.

The boundary line recognition apparatus 20 includes a candidate detecting unit 22, a dowel bar determining unit 24, and a boundary line recognizing unit 26, as configurations of the functions actualized as a result of the CPU running the program. The method by which these elements that configure the boundary line recognition apparatus 20 are actualized is not limited to software. Some or all of the elements may be actualized through use of hardware combining logic circuits, analog circuits, and the like.

The candidate detecting unit 22 acquires, from the cameras 10, the image data of the periphery of the own vehicle 100 that has been picked up by the cameras 10. The candidate detecting unit 22 detects boundary line candidates based on the acquired image data. The boundary line candidates are candidates for the boundary lines that demarcate the driving lane in which the own vehicle 100 is driving.

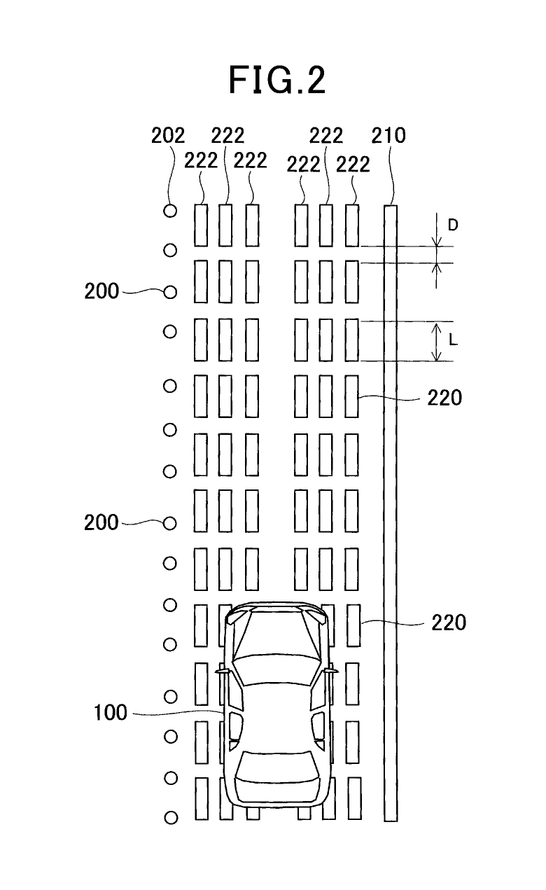

As shown in FIG. 2, Botts' dots 200, a white line 210, line segments 200 formed by dowel bars embedded in the road, and the like appear on a road surface.

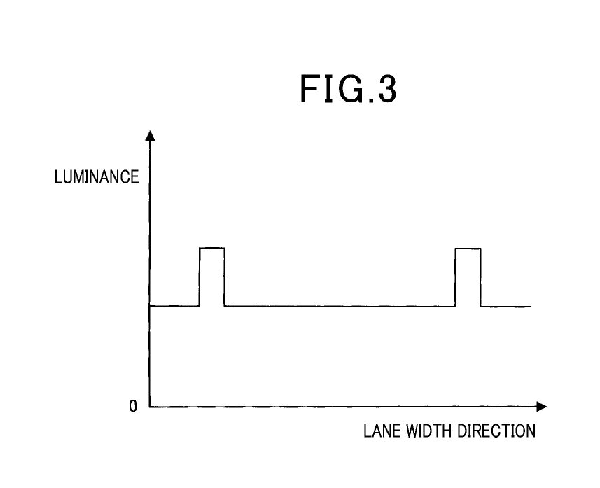

As shown in FIG. 3, the candidate detecting unit 22 detects the Botts' dots 200, the white line 210, and the line segments 220 based on differences in luminance between the road surface and the Botts' dots 200, the white line 210, and the line segments 220 in the image data. The Botts' dots 200, the white line 210, and the line segments 220 are typically brighter than the concrete on the road surface.

In FIG. 2, a boundary line candidate that is a series of dots 202 is recognized from the Botts' dots 200 that are set along a driving direction. In addition, a boundary line candidate that is a dashed line 222 is recognized from the line segments 220 that appear along the driving direction. In FIG. 2, three dashed lines 222 appear in each of the left and right areas ahead of the own vehicle 100. The white line 210 is recognized as a boundary line candidate that is a solid line.

The series of dots 202 and the white line 210 are actual boundary lines. Meanwhile, the dashed line 222 is a line formed by the dowel bars that are embedded in the road and is not an actual boundary line.

Here, depending on the method by which the dowel bars are embedded in the road, the line segments 220 may be darker than the road surface. In this case, a dashed line that is formed by the road surface between the line segments 220 in a lane width direction is recognized as the boundary line candidate. For example, in FIG. 2, when the line segments 220 are darker than the road surface, two dashed lines between the line segments 220 in each of the left and right areas ahead of the own vehicle 100 are detected as the boundary line candidates.

The dowel bar determining unit 24 determines whether or not the dashed line 222 formed by the dowel bars is present among the boundary line candidates detected by the candidate detecting unit 22, based on characteristics of the dowel bars, that is, positions in which the dowel bars are embedded and a configuration of the dowel bar itself.

The boundary line recognizing unit 26 eliminates, from the boundary line candidates detected by the candidate detecting unit 22, the boundary line candidate determined to be formed by the dowel bars by the dowel bar determining unit 24. The boundary line recognizing unit 26 then outputs the boundary line candidates that remain after elimination of the boundary line candidates formed by the dowel bars to the driving assistance apparatus as boundary lines.

### [1-2. Processes]

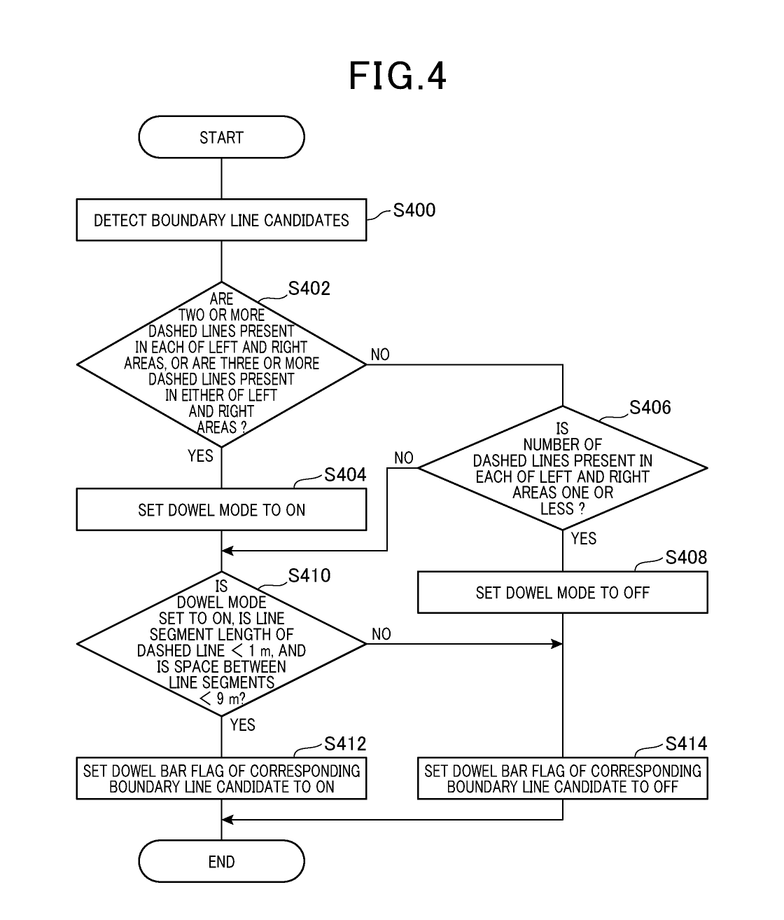

A boundary line recognition process performed by the boundary line recognition apparatus 20 will be described below with reference to the flowchart in FIG. 4. Steps in the flowchart in FIG. 4 are performed at all times at a predetermined time interval.

At step S400, the candidate detecting unit 22 detects the boundary line candidates that are present ahead of the own vehicle 100, based on the image data acquired from the cameras 10. For example, in FIG. 2, the candidate detecting unit 22 detects the single series of dots 202, the single white line 210, and the three dashed lines 222 that are present in each of the left and right areas ahead of the own vehicle 100.

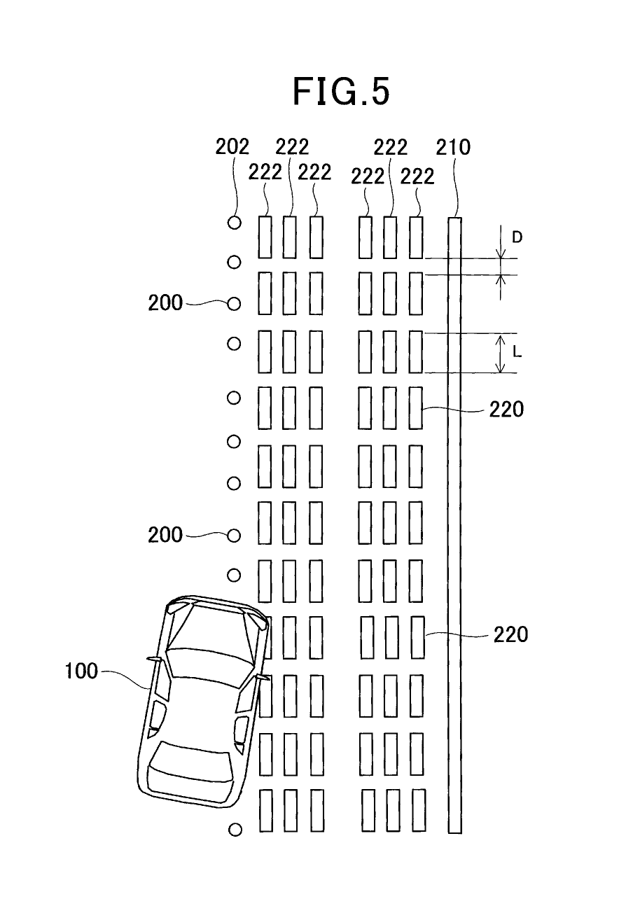

The candidate detecting unit 22 detects the boundary line candidates that are present ahead of the own vehicle 100 not only when the own vehicle 100 is driving along the driving lane as shown in FIG. 2, but also when the own vehicle 100 is changing lanes as shown in FIG. 5. In FIG. 5, the candidate detecting unit 22 detects three or more dashed lines 222 in the area to the right of the own vehicle 100.

At step S402, the dowel bar determining unit 24 determines whether or not two or more dashed lines 222 are present in each of the left and right areas ahead of the own vehicle 100, or whether or not three or more dashed lines 222 are present in either of the left and right areas, based on the boundary line candidates detected by the candidates detecting unit 22.

When determined Yes at step S402, that is, when determined that two or more dashed lines 222 are present in each of the left and right areas ahead of the own vehicle 100, or three or more dashed lines 222 are present in either of the left and right areas, at step S404, the dowel bar determining unit 24 sets a dowel mode to on and advances the process to step S410. A value of the dowel mode that has been set in a previous boundary line recognition process is held at the start of a current boundary line recognition process.

The determination at step S402 being No, that is, two or more dashed lines 222 not being present in each of the left and right areas ahead of the own vehicle 100, and three or more dashed lines 222 not being present in either of the left and right areas indicate that the number of dashed lines 222 that are present in either of the left and right areas ahead of the own vehicle 100 is one or less, and the number of dashed lines 222 that are present in each of the left and right areas is two or less.

That is, the determination at step S402 being No indicates that the number of dashed lines 222 that are present in one of the left and right areas ahead of the own vehicle 100 is one or less, and the number of dashed lines 222 present in the other of the left and right areas is two or less. In this case, at step S406, the dowel bar determining unit 24 determines whether or not the number of dashed lines 222 that are present in each of the left and right areas ahead of the own vehicle 100 is one or less.

When determined Yes at step S406, that is, when determined that the number of dashed lines 222 that are present in each of the left and right areas ahead of the own vehicle 100 is one or less, the dowel bar determining unit 24 determines that the dashed line 222 formed by the dowel bars is unlikely to be present in the left and right areas ahead of the own vehicle 100. In this case, at S408, the dowel bar determining unit 24 sets the dowel mode to off. At step S414, the boundary line recognizing unit 26 sets a dowel bar flag of the corresponding dashed line 222 to off.

The boundary line candidate of which the dowel bar flag is set to off remains a boundary line candidate and is recognized as a boundary line.

The determination at step S406 being No, that is, the number of dashed lines 222 that are present in each of the left and right areas ahead of the own vehicle 100 not being one or less indicates that two dashed lines 222 are present in either of the left and right areas ahead of the own vehicle 100, because the determination at step S402 is No.

In this case, the dowel bar determining unit 24 determines that the two dashed lines 222 that are present in either of the left and right areas ahead of the own vehicle 100 are likely to be the dashed lines 222 formed by the dowel bars. The dowel bar determining unit 24 then advances the process to step S410.

At step S410, the dowel bar determining unit 24 determines whether or not all of conditions (1) to (3), below, are met. The conditions (2) and (3) are characteristics of the dashed line 222 that is formed by the dowel bars.

(1) The dowel mode is set to on.

(2) A length L of the line segment 220 is less than 1 meter.

(3) A space D between the line segments 220 in the driving direction is less than 9 meters.

When the dowel bar determining unit 24 determines Yes at step S410, that is, when the likelihood of the dashed lines 222 being formed by the dowel bars is high, at step S412, the boundary line recognizing unit 26 sets the dowel bar flags of the corresponding dashed lines 22 to on. The boundary line candidates of which the dowel bar flags are set to on are eliminated from the boundary line candidates.

The dowel bar flag is set for each of the series of dots 202, the white line 210, and the dashed lines 222 detected by the candidate detecting unit 22. The dowel bar flag being set to on indicates that the corresponding boundary line candidate is formed by the dowel bars. The dowel bar flag being set to off indicates that the corresponding boundary line candidate is not formed by the dowel bars and is an actual boundary line.

When determined No at step S410, that is, when determined that the likelihood of the dashed lines 222 being formed by the dowel bars is low, at step S414, the boundary line recognizing unit 26 sets the dowel bar flags of the corresponding dashed lines 222 to off.

After completing the boundary line recognition process shown in FIG. 4, the boundary line recognizing unit 26 recognizes the boundary line candidates of which the dowel bar flags are set to off as the boundary lines. The boundary line recognizing unit 26 then outputs the recognized boundary lines to the driving assistance apparatus (not shown).

### [1-3. Effects]

According to the first embodiment described above, the following effects can be obtained.

When the dashed lines 222 are recognized as being formed by the dowel bars based on the characteristics indicated by a boundary line candidate that is formed by dowel bars, the dashed lines 222 are eliminated from the boundary line candidates for boundary line recognition. As a result, a boundary line candidate formed by the dowel bars being erroneously recognized as a boundary line can be suppressed.

Consequently, the driving assistance apparatus performing a driving assistance process, such as lane departure warning or lane keeping assist, based on the dashed lines 222 present within a lane width between the series of dots 202 and the white line 210 that are actual boundary lines can be suppressed.

According to the above-described first embodiment, the camera 10 corresponds to a detecting unit. The image data acquired from the camera 10 by the candidate detecting unit 22 corresponds to detection data. The series of dots 202, the white line 210, and the dashed line 222 correspond to boundary line candidates. The series of dots 202 and the white line 210 correspond to boundary lines. The dashed line 222 corresponds to a boundary line candidate formed by dowel bars.

In addition, step S400 corresponds to a process performed by a candidate detecting unit. Steps S402 to S410 correspond to processes performed by a dowel bar determining unit. Steps S412 and S414 correspond to processes performed by a boundary line recognizing unit.

### 2. Second Embodiment

[2-1. Differences with the First Embodiment]

A configuration of a boundary line recognition apparatus according to a second embodiment is essentially identical to the configuration of the boundary line recognition apparatus according to the first embodiment. Meanwhile, according to the second embodiment, a boundary line recognition process described hereafter differs from the boundary line recognition process according to the first embodiment. According to the second embodiment, constituent sections that are identical to those according to the first embodiment are given the same reference numbers. The preceding descriptions are applicable to the constituent sections that are given the same reference numbers as those according to the first embodiment.

### [2-2. Processes]

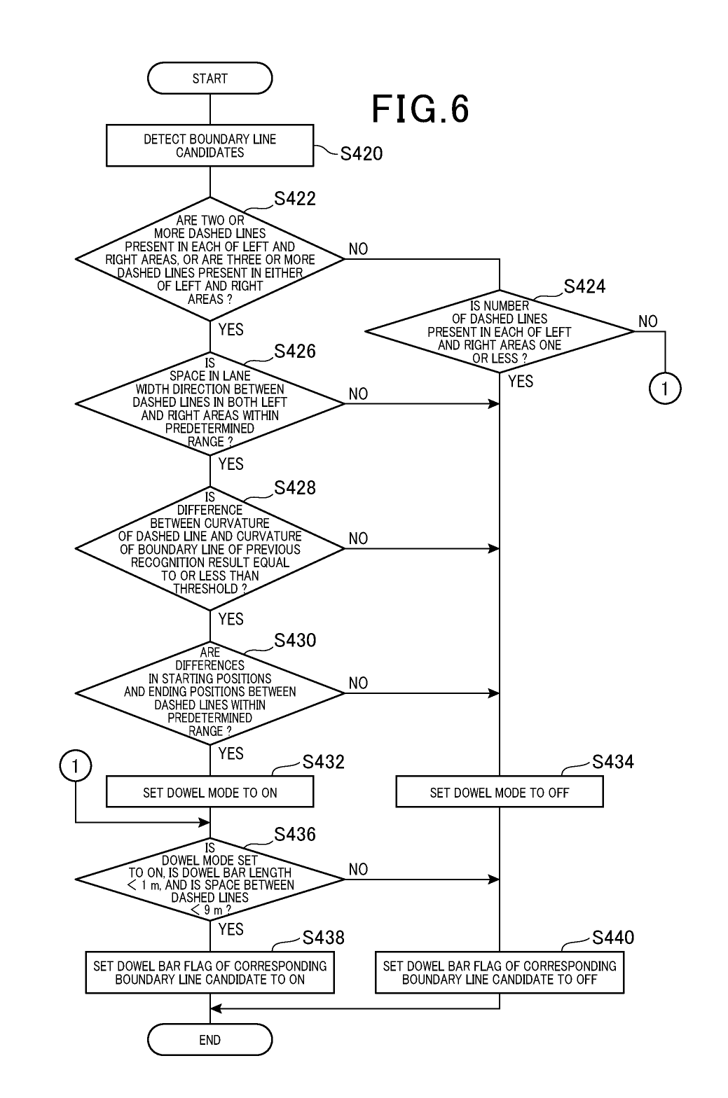

Steps in the flowchart of the boundary line recognition process shown in FIG. 6 are performed at all times at a predetermined time interval, in place of the steps in the flowchart in FIG. 4 according to the first embodiment. Here, processes at steps S420 to S424 and S432 to S440 are essentially identical to the processes at steps S400 to S414 in FIG. 4 according to the first embodiment. Therefore, descriptions thereof are omitted.

When determined Yes at steps S422, at S426, the dowel bar determining unit 24 determines whether or not spacing in the lane width direction between the dashed lines 222 in both the left and right areas ahead of the own vehicle 100 is within a predetermined range that allows the determination to be made that the dashed lines 222 are formed by the dowel bars.

When determined No at step S426, that is, when determined that the spacing in the lane width direction between the dashed lines 222 falls outside of the predetermined range, at step S434, the dowel bar determining unit 24 sets the dowel mode to off. At step S440, the boundary line recognizing unit 26 sets the dowel bar flags for the corresponding dashed lines 222 to off.

When determined Yes at step S426, that is, when determined that the spacing in the lane width direction between the dashed lines 222 is within a predetermined range, at step S428, the dowel bar determining unit 24 determines whether or not a difference between a curvature of the dashed lines 222 and a curvature of a boundary line when the boundary line has been recognized at the previous boundary line recognition process is equal to or less than a predetermined value. The curvature of the dashed lines 222 and the curvature of the boundary line may be calculated through analysis of the image data. Alternatively, the curvatures may be calculated based on the vehicle speed detected by the vehicle speed sensor 12 and the yaw rate detected by the yaw rate sensor 14.

The curvature of the road typically does not suddenly change even while the own vehicle 100 is driving. Therefore, the curvature of the boundary lines that demarcate the driving lane and the curvature of the dashed lines 222 formed by the dowel bars also do not suddenly change.

Therefore, when the determination at step S428 is No, that is, when the difference between the curvature of the dashed lines 222 and the curvature of the boundary line when the boundary line has been recognized in the previous boundary line recognition process is greater than the predetermined value, the dashed lines 222 can be determined to not be formed by the dowel bars. In this case, at step S434, the dowel bar determining unit 24 sets the dowel mode to off. At step S440, the boundary line recognizing unit 26 sets the dowel bar flags of the corresponding dashed lines 222 to off.

When determined Yes at step S428, that is, when determined that the difference between the curvature of the dashed lines 222 and the curvature of the boundary line when the boundary line has been recognized in the previous boundary line recognition process is equal to or less than the predetermine value, at step S430, the dowel bar determining unit 24 determines whether or not an amount of positional misalignment among the plurality of line segments 220 that are present in the lane width direction and configure the dashed lines 220 is within a predetermined range. Here, the amount of positional misalignment relates to starting positions at which the line segments 220 start and to ending positions at which the line segments 220 end in the driving direction.

A plurality of dowel bars are embedded in the lane width direction in the positions of the grooves that are dug at a predetermined interval in the driving direction. Therefore, if the line segments 220 are formed by the dowel bars, the respective amounts of positional misalignment regarding the starting positions and the ending positions among the line segments 220 are within a predetermined range.

Therefore, when the determination at step S430 is No, that is, when the respective amounts of positional misalignment regarding the starting positions and the ending positions among the plurality of line segments 220 that are present in the lane width direction and configure the dashed lines 220 fall outside of the predetermined range, the dashed lines 222 can be determined to not be formed by the dowel bars. In this case, at step S434, the dowel bar determining unit 24 sets the dowel mode to off. At step S440, the boundary line recognizing unit 26 sets the dowel bar flags of the corresponding dashed lines 222 to off.

When determined Yes at step S430, that is, when determined that the respective amounts of positional misalignment regarding the starting positions and the ending positions among the plurality of line segments 220 that are present in the lane width direction and configure the dashed lines 220 are within a predetermined range, at step S432, the dowel bar determining unit 24 sets the dowel mode to off and advances the process to step S436.

### [2-3. Effects]

According to the second embodiment, the following effects can be obtained in addition to the effects according to the first embodiment.

According to the second embodiment, whether or not the dashed lines 222 are formed by the dowel bars is determined based on the spacing in the lane width direction between the dashed lines 222, the difference between the curvature of the current dashed lines 222 and the curvature of the boundary line recognized in the previous boundary line recognition process, and the respective amounts of positional misalignment regarding the starting positions and the ending positions in the driving direction of the line segments 220 configuring the dashed lines 222, in addition to a line type of the boundary line candidate, a quantity of boundary line candidates of which the line type is a dashed line and are present in the left and right areas ahead of the own vehicle 100, the spacing in the driving direction in the dashed line 222, and the length of the line segment 222 that are determined according to the first embodiment.

Consequently, according to the second embodiment, whether or not the dashed lines 222 are formed by the dowel bars can be determined with higher accuracy than that according to the first embodiment.

According to the second embodiment described above, step S420 corresponds to a process performed by the candidate detecting unit. Steps S422 to S436 correspond to processes performed by the dowel bar determining unit. Steps S438 and S440 correspond to processes performed by the boundary line recognizing unit.

### 3. Third Embodiment

### [3-1. Configuration]

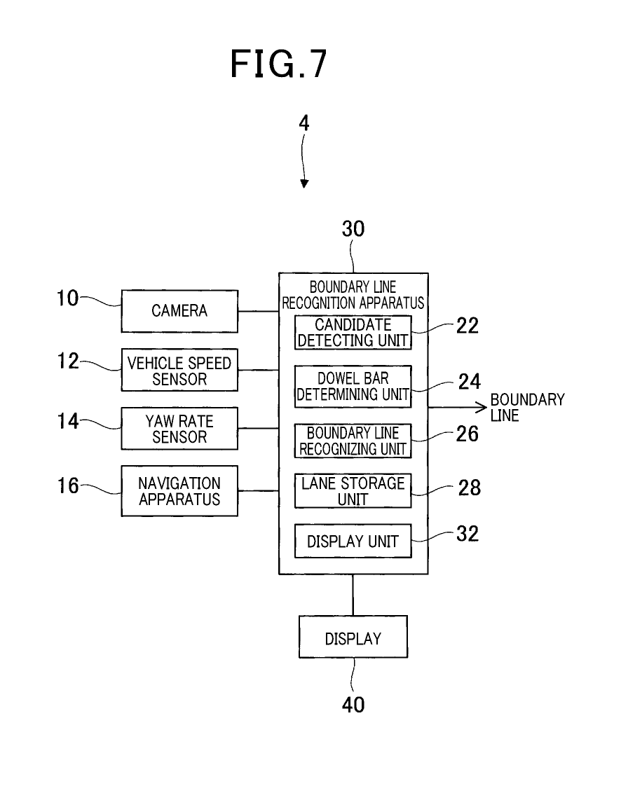

A boundary line recognition system 4 according a third embodiment shown in FIG. 7 includes the cameras 10, the vehicle speed sensor 12, the yaw rate sensor 14, the navigation apparatus 16, a boundary line recognition apparatus 30, and a display 40. According to the third embodiment, constituent sections that are identical to those according to the first embodiment are given the same reference numbers. The preceding descriptions are applicable to the constituent sections that are given the same reference numbers as those according to the first embodiment.

The boundary line recognition apparatus 30 includes the candidate detecting unit 22, the dowel bar determining unit 24, the boundary line recognizing unit 26, a lane storage unit 32, and a display unit 34 as configurations of functions actualized as a result of the CPU running a program.

The lane storage unit 32 stores a stored boundary line position and a stored lane width in a storage apparatus such as the RAM (not shown). The stored boundary line position is a lateral position of a boundary line recognized by the boundary line recognizing unit 26, with respect to the own vehicle 100. The stored lane width is a lane width of the driving lane indicated by a width between the boundary lines to the left and right of the own vehicle 100.

The display unit 34 displays the boundary lines of a lane recognized by the boundary line recognizing unit 26 in the display 40. The display 40 displays the boundary lines that demarcate the driving lane in which the own vehicle 100 is driving based on a command from the display unit 34 of the boundary line recognition apparatus 30. In addition, the display 40 may be shared between the navigation apparatus 16 and the boundary line recognition apparatus 20.

### [3-2. Processes]

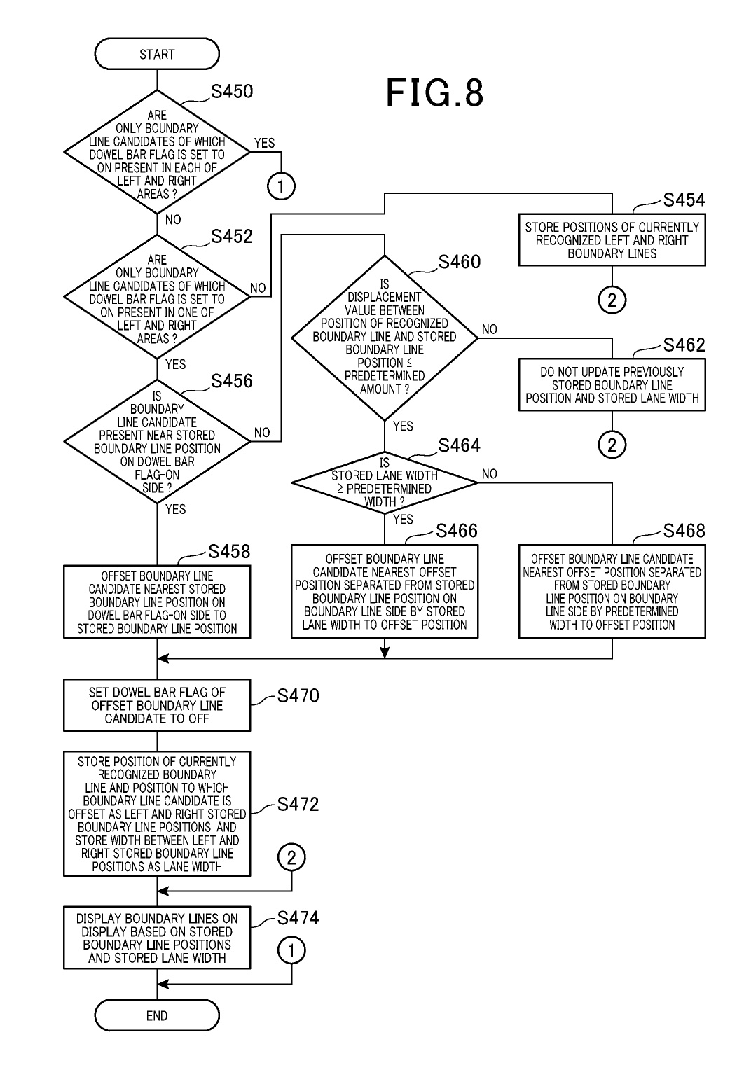

A boundary line recognition process according to the third embodiment shown in FIG. 8 is performed after the boundary line recognition process according to the first embodiment in FIG. 4 or the boundary line recognition process according to the second embodiment in FIG. 7.

At step S450, the boundary line recognizing unit 26 determines whether or not only boundary line candidates of which the dowel bar flag is set to on are present in each of the left and right areas ahead of the own vehicle 100. Presence of only the boundary line candidates of which the dowel bar flag is set to on indicates that actual boundary lines such as the series of dots 202 and the white line 210 cannot be recognized.

When determined Yes at step S450, that is, when determined that only the boundary line candidates of which the dowel bar flag is set to on are present in each of the left and right areas ahead of the own vehicle 100, the boundary line recognizing unit 26 determines that boundary lines cannot be recognized and ends the boundary line recognition process.

When determined No at step S450, that is, when a boundary line candidate of which the dowel bar flag is set to off is present in at least either of the left and right areas ahead of the own vehicle 100, at step S452, the boundary line recognizing unit 26 determines whether or not only the boundary line candidates of which the dowel bar flag is set to on are present in one of the left and right areas ahead of the own vehicle 100.

When determined Yes at step S452, that is, when determined that only the boundary line candidates of which the dowel bar flag is set to on are present in one of the left and right areas ahead of the own vehicle 100, the boundary line recognizing unit 26 advances the process to step S456.

The determination at step S452 being No, that is, the boundary line candidate of which the dowel bar flag is set to off being present in each of the left and right areas ahead of the own vehicle 100 indicates that the boundary lines are recognized in each of the left and right areas ahead of the own vehicle 100. In this case, at step S454, the lane storage unit 32 stores the positions of the currently recognized boundary lines as the stored boundary line positions. In addition, the lane storage unit 32 stores the width between the left and right boundary lines as the stored lane width. The lane storage unit 32 then advances the process to step S474.

At step S456, the boundary line recognizing unit 26 determines whether or not a boundary line candidate is present near the stored boundary line position on the side on which only the boundary line candidates of which the dowel bar flag is set to on are present. When determined No at step S456, that is, when a boundary line candidate is not present near the stored boundary line position on the side on which only the boundary line candidates of which the dowel bar flag is set to on are present, the boundary line recognizing unit 26 advances the process to step S460.

When determined Yes at step S456, that is, when determined that when a boundary line candidate is present near the stored boundary line position on the side on which only the boundary line candidates of which the dowel bar flag is set to on are present, at step S458, the boundary line recognizing unit 26 offsets, to the stored boundary line position, the position of the boundary line candidate that is nearest the stored boundary line position on the side on which only the boundary line candidates of which the dowel bar flag is set to on are present, with this boundary line candidate serving as the boundary line. After completing step S458, the boundary line recognizing unit 26 advances the process to step S470.

At step S460, the boundary line recognizing unit 26 determines whether or not an amount of displacement between the position of the boundary line that is currently recognized as an actual boundary line and the position of the previous stored boundary line position is equal to or less than a predetermined amount.

When the amount of displacement between the position of the boundary line that is currently recognized as an actual boundary line and the position of the previous stored boundary line position is equal to or less than the predetermined amount, the position of the currently recognized boundary line can be determined to be correct. Conversely, when the amount of displacement between the position of the boundary line that is currently recognized as an actual boundary line and the position of the previous stored boundary line position is greater than the predetermined amount, a determination can be made that there is a likelihood that the position of the currently recognized boundary line is erroneously recognized.

When the determination at step S460 is No, that is, when the amount of displacement between the position of the boundary line that is currently recognized as an actual boundary line and the position of the previous stored boundary line position is greater than the predetermined amount, at step S462, the lane storage unit 32 does not update the stored boundary line positions and the stored lane width that have previously been stored. The lane storage unit 32 then advances the process to step S474.

When determined Yes at step S460, that is, when determined that the amount of displacement between the position of the boundary line that is currently recognized as an actual boundary line and the position of the previous stored boundary line position is equal to or less than the predetermined amount, at step S464, the boundary line recognizing unit 26 determines whether or not the stored lane width that has been previously stored is equal to or greater than a predetermined width. The predetermined width is set to a lower-limit value required for a lane width.

When determined Yes at step S464, that is, when the stored lane width that has been previously stored is equal to or greater than the predetermined width, at step S466, the boundary line recognizing unit 26 offsets, to an offset position that is separated from the previous stored boundary line position on the actual boundary line side by a distance amounting to the stored lane width, a boundary line candidate nearest the offset position, with this boundary line candidate serving as the boundary line. The boundary line recognizing unit 26 then advances the process to step S470.

When determined No at step S464, that is, when the stored lane width that has been previously stored is less than the predetermine width, at step S468, the boundary line recognizing unit 26 offsets, to an offset position that is separated from the previous stored boundary line position on the actual boundary line side by a distance amounting to the predetermined width, to boundary line candidate nearest the offset position, with this boundary line candidate serving as the boundary line. The boundary line recognizing unit 26 then advances the process to step S470.

At step S470, the boundary line recognizing unit 26 sets the dowel bar flag of the boundary line candidate that has been offset at steps S458, S466, or S468 to off.

Then, at step S472, the lane storage unit 32 stores the position of the boundary line that is currently recognized as an actual boundary line and the position to which the boundary line candidate is offset as the stored boundary line positions. The lane storage unit 32 also stores the width between the left and right stored boundary line positions as the stored lane width. The lane storage unit 32 then advances the process to step S474.

At step S474, the display unit 34 displays the boundary lines to the left and right of the own vehicle in the display 40, based on the stored boundary line positions and the stored lane width that are currently stored.

### [3-3. Effects]

According to the third embodiment, the following effects can be obtained in addition to the effects according to the first embodiment or the effects according to the second embodiment.

According to the third embodiment, even in cases in which only the boundary line candidates of which the dowel bar flag is set to on are present in one of the left and right areas ahead of the own vehicle 100, the position of the boundary line on the side on which only the boundary line candidates of which the dowel bar flag is set to on are present can be estimated based on the stored boundary line positions and the stored lane width that have been previously stored.

According to the above-described third embodiment, steps S450 to S470 correspond to processes performed by the boundary line recognizing unit. Steps S454, S462, and S472 correspond to processes performed by the lane storage unit. Step S474 corresponds to a process performed by the display unit.

### 4. Fourth Embodiment

### [4-1. Processes]

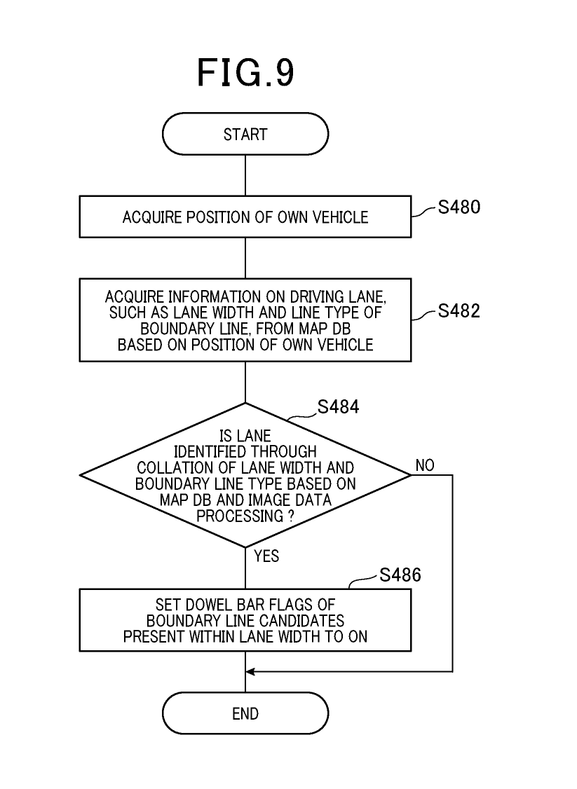

A boundary line recognition process according to a fourth embodiment shown in FIG. 9 is performed after the boundary line recognition process according to the first embodiment in FIG. 4 or the boundary line recognition process according to the second embodiment in FIG. 7.

At step S480, the dowel bar determining unit 24 acquires the position of the own vehicle from the navigation apparatus 16. At step S482, the dowel bar determining unit 24 acquires information on the driving lane in which the own vehicle is driving from the map DB in the navigation apparatus 16, based on the position of the own vehicle. The information on the driving lane includes the lane width of the driving lane, the line type of the boundary line demarcating the driving lane, and the like.

At step S484, the dowel bar determining unit 24 collates the information on the driving lane acquired from the navigation apparatus 16 and the information on the driving lane such as the line types and the quantity of the boundary line candidates detected by the candidate detecting unit 22 through image analysis of the image data acquired from the camera 10, the width between the boundary lines recognized by the boundary line recognizing unit 26, and the like. The dowel bar determining unit 24 then determines whether or not the driving lane in which the own vehicle 100 is driving can be identified.

When determined No at step S484, that is, when determined that the collation result indicates that the information on the driving lane acquired from the navigation apparatus 16 and the information on the driving lane acquired from the candidate detecting unit 22 and the boundary line recognizing unit 26 do not match, the dowel bar determining unit 24 determines that the driving lane in which the own vehicle 100 is driving cannot be identified. The dowel bar determining unit 24 then ends the boundary line recognition process.

When determined Yes at step S484, that is, when determined that the collation result indicates that the information on the driving lane acquired from the navigation apparatus 16 and the information on the driving lane acquired from the candidate detecting unit 22 and the boundary line recognizing unit 26 match, the dowel bar determining unit 24 determines that the driving lane in which the own vehicle 100 is driving can be identified.

In this case, at S486, the boundary line recognizing unit 26 sets the dowel bar flags of the boundary line candidates present within the lane width of the driving lane to on.

Here, when information such as the quantity and positions of the embedded dowel bars is registered in the map DB, the driving lane in which the own vehicle 100 is driving may be identified through collation of the information on the dowel bars acquired from the navigation apparatus 16 and the information on the driving lane acquired from the candidate detecting unit 22 and the boundary line recognizing unit 26.

### [4-2. Effects]

According to the fourth embodiment, the following effects can be obtained in addition to the effects according to the first embodiment or the effects according to the second embodiment.

The driving lane in which the own vehicle 100 is driving can be identified with high accuracy based on the result of collation between the information on the driving lane acquired from the navigation apparatus 16 and the information on the driving lane acquired from the candidate detecting unit 22 and the boundary line recognizing unit 26.

Consequently, a determination that the boundary line candidates present within the lane width of the identified driving lane are formed by dowel bars can be made with high accuracy.

According to the above-described fourth embodiment, steps S480 to S484 correspond to processes performed by the dowel bar determining unit. Step S486 corresponds to a process performed by the boundary line recognizing unit.

### 5. Other Embodiments

(1) A following process may be added to the determination regarding whether or not the dashed lines 222 are formed by the dowel bars, shown in the flowchart according to the first embodiment in FIG. 4. That is, for example, as shown in FIG. 2, the dashed lines 222 that are present near the wheels of the own vehicle 100 and are present between the series of dots 202 and the white line 210 that are predicted to be actual boundary lines may be determined to be the dashed line 222 formed by dowel bars.

(2) According to the above-described embodiments, the boundary line candidates are recognized from the image data picked by a camera that serves as a detecting unit that detects the boundary line candidates. In addition to the camera, for example, a light detection and ranging (LiDAR) apparatus may be used as the detecting unit. In this case, the boundary line candidate is recognized based on the strength of reflected light received by the LiDAR apparatus.

(3) A plurality of functions provided by a single constituent element according to the above-described embodiments may be actualized by a plurality of constituent elements. A single function provided by a single constituent element may be actualized by a plurality of constituent elements. In addition, a plurality of functions provided by a plurality of constituent elements may be actualized by a single constituent element. A single function provided by a plurality of constituent elements may be actualized by a single constituent element. Furthermore, a part of a configuration according to the above-described embodiments may be omitted. Moreover, at least a part of a configuration according to an above-described embodiments may be added to or replace a configuration according to another of the above-described embodiments. Any embodiment included in the technical concept specified solely by the wordings of the claims is an embodiment of the present invention.

(4) The present invention can also be actualized by various modes in addition to the above-described boundary line recognition apparatuses 20 and 30, such as the boundary line recognition systems 2 and 4 of which the boundary line recognition apparatuses 20 and 30 are respective constituent elements, a boundary line recognition program enabling a computer to function as the boundary line recognition apparatuses 20 and 30, a recording medium on which the boundary line recognition program is recorded, and a boundary line recognition method.

What is claimed is:

1. A boundary line recognition apparatus that is mounted in an own vehicle (100) and recognizes a boundary line (202, 210) that demarcates a driving lane in which the own vehicle is driving, the boundary line recognition apparatus comprising:
a candidate detecting unit (22, S400, S420) that detects line types of boundary line candidates (202, 210, 222) that are candidates for the boundary line and a quantity of boundary line candidates of the same line type, based on detection data of the boundary line candidates acquired from a detecting unit (10) that detects the boundary line candidates;
a dowel bar determining unit (24, S402 to S410, S422 to S436, S480 to S484) that determines whether or not the boundary line candidates are formed by dowel bars embedded in a road, based on the line type and quantity detected by the candidate detecting unit; and
a boundary line recognizing unit (26, S412, S414, S438, S440, S450 to S470, S486) that eliminates the boundary line candidates that are determined to be formed by the dowel bars by the dowel bar determining unit, and recognizes the boundary line.

2. The boundary line recognition apparatus according to claim 1, wherein:
the dowel bar determining unit (S402, S406, S422, S424) determines that the boundary line candidates are formed by the dowel bars when the candidate detecting unit detects that a plurality of adjacent boundary line candidates are dashed lines.

3. The boundary line recognition apparatus according to claim 2, wherein:
the dowel bar determining unit (S426, S428) determines whether or not the boundary line candidates are formed by the dowel bars based on spacing in a width direction of the driving lane between the boundary line candidates and the curvature of the boundary line candidates.

4. The boundary line recognition apparatus according to claim 3, wherein:
the dowel bar determining unit determines that the boundary line candidates that are present near wheels of the own vehicle and are present between predicted boundary lines are formed by the dowel bars.

5. The boundary line recognition apparatus according to claim 4, wherein:
the dowel bar determining unit (S410, S430, S436) determines whether or not the boundary line candidates are formed by the dowel bars based on at least one of a length of a line segment configuring the dashed line, spacing between the line segments in the driving direction, and starting positions or ending positions of the line segments, when the boundary line candidates are dashed lines.

6. The boundary line recognition apparatus according to claim 5, wherein:
the boundary line recognizing unit (S450) recognizes that the boundary line is not present when the dowel bar determining unit determines that all of the boundary line candidates are formed by the dowel bars.

7. The boundary line recognition apparatus according to claim 5, further comprising:
a lane storage unit (32, S454, S462, S472) that stores, in a storage apparatus, a lane width of the driving lane and positions of the boundary lines based on the boundary lines recognized by the boundary line recognizing unit, wherein:
when all of the boundary line candidates in at least one of left and right areas ahead of the own vehicle are formed by the dowel bars based on a current recognition result, and when at least one of the boundary line candidates is present within a predetermined range near a stored position of the boundary line that is stored in the storage apparatus by the lane storage unit, the boundary line recognizing unit (S458) offsets, to the stored position, one of the boundary line candidates nearest the stored position among the at least one of the boundary line candidates, and recognizes the one of the boundary line candidates as the boundary line; and
when all of the boundary line candidates in one of left and right areas are formed by the dowel bars based on a current recognition result, and when none of the boundary line candidates is present within a predetermined range near the stored position, the boundary line recognizing unit (S466 to S470) offsets, to an offset position, a first boundary line candidate of the boundary line candidates nearest the offset position among the all of the boundary line candidates, and recognizes the first boundary line candidate as the boundary line, the offset position being separated from a position of the boundary line recognized in the other of the left and right areas by a distance amounting to the lane width or by a distance amounting to a predetermined lane width.

8. The boundary line recognition apparatus according to claim 6, wherein:
the dowel bar determining unit (S480 to S484) determines whether or not the boundary line candidates formed by the dowel bars are present in the driving lane, based on information related to a driving position of the own vehicle and the driving lane at the driving position acquired from a navigation apparatus (16), the line types of the boundary line candidates and the quantity of boundary line candidates of the same line type detected by the candidate detecting unit, and the width between the boundary lines recognized by the boundary line recognizing unit.

9. The boundary line recognition apparatus according to claim 7, wherein:
the dowel bar determining unit (S480 to S484) determines whether or not the boundary line candidates formed by the dowel bars are present in the driving lane, based on information related to a driving position of the own vehicle and the driving lane at the driving position acquired from a navigation apparatus (16), the line types of the boundary line candidates and the quantity of boundary line candidates of the same line type detected by the candidate detecting unit, and the width between the boundary lines recognized by the boundary line recognizing unit.

10. The boundary line recognition apparatus according to claim 8, further comprising:
a display unit (34, S474) that displays the boundary lines recognized by the boundary line recognizing unit in a display apparatus (40).

11. The boundary line recognition apparatus according to claim 9, further comprising:
a display unit (34, S474) that displays the boundary lines recognized by the boundary line recognizing unit in a display apparatus (40).

12. The boundary line recognition apparatus according to claim 1, wherein:
the dowel bar determining unit (S426, S428) determines whether or not the boundary line candidates are formed by the dowel bars based on spacing in a width direction of the driving lane between the boundary line candidates and the curvature of the boundary line candidates.

13. The boundary line recognition apparatus according to claim 1, wherein:
the dowel bar determining unit determines that the boundary line candidates that are present near wheels of the own vehicle and are present between predicted boundary lines are formed by the dowel bars.

14. The boundary line recognition apparatus according to claim 1, wherein:
the dowel bar determining unit (S410, S430, S436) determines whether or not the boundary line candidates are formed by the dowel bars based on at least one of a length of a line segment configuring the dashed line, spacing between the line segments in the driving direction, and starting positions or ending positions of the line segments, when the boundary line candidates are dashed lines.

15. The boundary line recognition apparatus according to claim 1, wherein:
the boundary line recognizing unit (S450) recognizes that the boundary line is not present when the dowel bar determining unit determines that all of the boundary line candidates are formed by the dowel bars.

16. The boundary line recognition apparatus according to claim 1, further comprising:
a lane storage unit (32, S454, S462, S472) that stores, in a storage apparatus, a lane width of the driving lane and positions of the boundary lines based on the boundary lines recognized by the boundary line recognizing unit, wherein:
when all of the boundary line candidates in at least one of left and right areas ahead of the own vehicle are formed by the dowel bars based on a current recognition result, and when at least one of the boundary line candidates is present within a predetermined range near a stored position of the boundary line that is stored in the storage apparatus by the lane storage unit, the boundary line recognizing unit (S458) offsets, to the stored position, one of the boundary line candidates nearest the stored position among the at least one of the boundary line candidates, and recognizes the one of the boundary line candidates as the boundary line; and
when all of the boundary line candidates in one of left and right areas are formed by the dowel bars based on a current recognition result, and when none of the boundary line candidates is present within a predetermined range near the stored position, the boundary line recognizing unit (S466 to S470) offsets, to an offset position, one of the boundary line candidates nearest the offset position among the all of the boundary line candidates, and recognizes the one of the boundary line candidates as the boundary line, the offset position being separated from a position of the boundary line recognized in the other of the left and right areas by a distance amounting to the lane width or by a distance amounting to a predetermined lane width.

17. The boundary line recognition apparatus according to claim 1, wherein:
the dowel bar determining unit (S480 to S484) determines whether or not the boundary line candidates formed by the dowel bars are present in the driving lane, based on information related to a driving position of the own vehicle and the driving lane at the driving position acquired from a navigation apparatus (16), the line types of the boundary line candidates and the quantity of boundary line candidates of the same line type detected by the candidate detecting unit, and the width between the boundary lines recognized by the boundary line recognizing unit.

18. The boundary line recognition apparatus according to claim 1, further comprising:
a display unit (34, S474) that displays the boundary lines recognized by the boundary line recognizing unit on a display apparatus (40).

19. A boundary line recognition method comprising:
detecting, by a boundary line recognition apparatus that is mounted in an own vehicle and recognizes a boundary line that demarcates a driving lane in which the own vehicle is driving, line types of boundary line candidates that are candidates for the boundary line and a quantity of boundary line candidates of the same line type, based on detection data of the boundary line candidates acquired from a detecting unit that detects the boundary line candidates;
determining, by the boundary line recognition apparatus, whether or not the boundary line candidates are formed by dowel bars embedded in a road, based on the line type and quantity detected by the candidate detecting unit; and
eliminating the boundary line candidates that are determined to be formed by the dowel bars by the dowel bar determining unit and recognizing the boundary line by the boundary line recognition apparatus.
